(19) United States
(12) Patent Application Publication
(10) Pub. No.: US 2016/0294148 A1
(43) Pub. Date: Oct. 6, 2016

(54) HIGH EFFICIENCY LASER CAVITY

(71) Applicant: LUMENIS LTD., Yokneam Ilit (IL)

(72) Inventor: Haim EPSHTEIN, Benyamina (IL)

(21) Appl. No.: 15/087,764

(22) Filed: Mar. 31, 2016

Related U.S. Application Data
(60) Provisional application No. 62/141,454, filed on Apr. 1, 2015.

(51) Int. Cl. H01S 3/02; H01S 3/16; H01S 3/06; H01S 3/092

(52) U.S. Cl. CPC H01S 3/025; H01S 3/092; H01S 3/1623; H01S 3/1616; H01S 3/161; H01S 3/1643; H01S 3/061

(57) ABSTRACT

A pumped laser cavity includes two parallel glass tubes forming two cavities, a flashlamp for placement in one of the cavities, wherein either the flashlamp or one or more of the parallel glass tubes are doped with one or more of Samarium or Europium.

### RELATED APPLICATIONS

This application is related to and claims priority to U.S. Provisional Application Ser. No. 62/141,454, filed Apr. 1, 2015, and U.S. Provisional Application Ser. No. 62/142,502, filed Apr. 3, 2015, the entire contents of which are herein incorporated by reference.

### FIELD OF THE INVENTION

The present invention relates to laser devices, flashlamp pumped lasers and in particular flashlamp pumped Holmium lasers with high efficiency due to coatings provided to the flashlamp or to glass tubes associated with the flashlamp.

### BACKGROUND OF THE PRESENT INVENTION

Eye safe lasers having a wavelength range of approximately 2 μm and are characterized by a strong absorption peak in water. Since water is the main constituent of biological tissue, such lasers have exceptional advantages for medical applications requiring substantial, well confined heating, or which require precise cutting or ablation of biological tissue. For the above-mentioned wavelength, trivalent rare earth ions Tm³⁺ and Ho³⁺ have the most relevant laser transitions for continuous wave and pulsed laser operation, respectively. Both ions can be described as quasi three level lasers with thermally populated ground state. Due to a higher gain of holmium doped crystal, this ion is more attractive for pulsed or q-switched lasers. However, in order to achieve an efficient holmium laser operation at 2.1 μm, practicing the holmium ⁵I₇ to ⁵I₈ transition, holmium can only be excited directly (in-band) at around 1.9 μm or by exploiting an energy transfer process from thulium or ytterbium. Holmium's ⁵I₇ and ⁵I₈ levels characterized by a strong Stark splitting.

Co-doped thulium sensitized, flash lamp pumped holmium lasers are known in the prior art. This laser includes a thulium 2.0 μm laser created by the transition that starts in the ³F₄ level and ends in a thermally populated Stark level of the ³H₆ ground state to excite the holmium laser. YAG is the most commonly used host material for thulium lasers because of its high values of specific heat, heat conductivity and optical quality. With YAG as a host crystal, about 50% of the excitation energy is transferred to the holmium ions at room temperature. The rest of the energy is stored in the excited thulium ions. Thulium may be excited by around 800 nm from ground state to ³H₄level. Such excitation may create a cross relaxation process if doping concentration is high. It is also possible to pump ³F₄ energy level directly by using light of 1700-1800 nm. Laser efficiency may be decreased due to both phonon assisted up conversion and excited state absorption processes. The up conversion process which ends up with the higher energy level of ³H₄, has a minor efficiency decreasing effect since it also enhances cross relaxation. However, the up conversion process, which ends up at the lower energy level of ³H₅, has a more dominant efficiency decreasing effect since this level is characterized by a very short lifetime and it is mostly depopulated by a non-radiative process ³H₅→³F₄ which generates heat inside the crystal. In order to dissipate such heat, high thermal conductivity hosting materials have to be used such as YAG. Heat removal may also be improved by using special rod geometries. The higher the thulium doping concentration, the lower the thermal conductivity of the YAG and the shorter the lifetime of the upper laser level.

Tm:YAG has its main absorption peak at 785 nm. Most laser diodes were mainly developed for pumping Nd:YAG at 808 nm. Therefore, Tm doped crystals cannot be sufficiently pumped at their strongest absorption peak unless larger crystals or multi pump pass set-ups are used. However, in order to achieve high power laser, a high quality crystal is required with very few impurities and defects. Moreover, a strong pumping source is required. Such a strong source cannot be achieved by diodes but rather are achieved by a flash lamp.

The Holmium ground level of ⁵I₈ is about 2% thermally populated at room temperature similarly to Tm:YAG. However, the upper laser level in holmium is 10% thermally populated while in thulium it is 46%. Therefore, holmium temperature dependence is higher than thulium's. At high population density of the ₅I₇ energy level of Holmium, up conversion processes to energy levels of ⁵I₅ and ⁵I₆, which are phonon assisted and non-radiated, are a major source of heat and inefficiency.

The first flash lamp pumped YAG Holmium lasers required liquid nitrogen cooling. Er and Tm were used as doping material in order to optimize the absorption the pumping energy of the lamp. However, co-doping Tm and Ho in crystals has significant drawbacks—increased changes for up-conversion processes that populate ⁵I₅ and ⁵I₆ increase the thermal load in the crystal even if the cross relaxation process of the thulium ions is exploited very well. CO ions are more efficient than Er in absorbing the flash lamp light. A newer YAG crystal, CTH:YAG, is sensitized with Cr+³ which has a broad absorption band in visible spectrum which has a continuous overlap with the emission spectrum of a typical flash lamp. An overlap between the Cr⁴⁻³ fluorescence band and ³H₆->³F₃ absorption line of the Tm allows efficient transfer of energy from the Cr to the Tm ions. Excited ³F₃ Tm ions state are then relaxed to the ³H₄ followed by a cross relaxation to ³F₄. Then the excitation energy diffuses and trapped by the Ho+³ ions and exciting them to the ⁵I₇ state.

### SUMMARY OF THE PRESENT INVENTION

In an aspect, a method of improving the operation of a laser assembly includes: providing a glass element, wherein the glass element comprises two, parallel glass tubes for holding each one of a laser rod or a pumping flash lamp; then doping at least one of the two parallel glass tubes of the glass element with one or more of Samarium or Europium, whereby, upon excitation, the doped glass element absorbs at least part of the blue emission spectrum irradiated from the pumping flash lamp when activated. The laser rod may be a Holmium doped laser rod or a CTH:YAG doped laser rod.

In another aspect, a pumped laser cavity includes two tubes forming two parallel glass cavities, a flashlamp for placement in one of the glass cavities. The flashlamp is doped with one or more of Samarium or Europium.

In another aspect, a pumped laser cavity assembly includes two parallel tubes forming two glass cavities; a flashlamp within one of the glass cavities; a laser rod within the other of the two glass cavities; a glass tube surrounding one or both of the flashlamp or the laser rod; the glass tube is doped with one or more of Samarium or Europium.

In yet another aspect, a method for improving the operation of a laser assembly includes providing two parallel glass tubes, each having a cavity for holding one of a laser rod or a pumping flash lamp; doping the one or more glass tubes with one or more of: Samarium or Europium. Upon excitation, the one or more doped glass tubes absorb at least part of the blue emission spectrum irradiated from the pumping flash lamp. The laser rod is a Holmium doped laser rod or is a CTH:YAG doped laser rod.

In yet another aspect, a pumped laser cavity assembly includes two parallel glass tubes forming two cavities; a flashlamp within one of the cavities; a Holmium doped laser rod within the other of the cavities; the one or more of the glass tubes is doped with one or more of Samarium or Europium.

In yet a further aspect, a method of manufacturing a laser assembly includes providing a glass element, wherein the glass element comprises two, parallel glass tubes for holding each one of a laser rod or a pumping flash lamp; and, doping at least one of the two parallel glass tubes of the glass element with one or more of Samarium or Europium. Upon excitation of the doped laser assembly, the doped glass element absorbs at least part of the blue emission spectrum irradiated from the pumping flash lamp.

In an aspect, a multiple cavity laser system includes a controller configured to operate the system; a plurality of glass tubes forming laser cavities, each of the laser cavities including a flashlamp and a laser rod, the plurality of laser cavities also having an output end wherein, when activated by the controller, an output laser beam is emitted from the output end of each of the laser cavities. The controller redirects the output laser beams along a common optical axis, wherein the output laser beams of the plurality of laser cavities are combined along the common optical axis; and, one or more of the plurality of glass tubes forming the laser cavities are doped with one or more of Samarium or Europium.

### BRIEF DESCRIPTION OF THE DRAWINGS

FIG. 1 illustrates a flash lamp emission spectrum

FIG. 2 is an energy level diagram for Cr:Tm:Ho:YAG illustrating the flashlamp pumping scheme for the 2097 um laser transition.

FIG. 3 illustrates an assembly of a glass assembly for a laser rod and flashlamp.

FIG. 4 illustrates another embodiment of the assembly of FIG. 3.

FIG. 5 is a side view of the drawing of FIG. 3.

FIGS. 6-11 graphically illustrate the operation of the present invention in comparison to non-doped structures.

FIG. 12 illustrates a laser system which incorporates the doping structures of the present invention

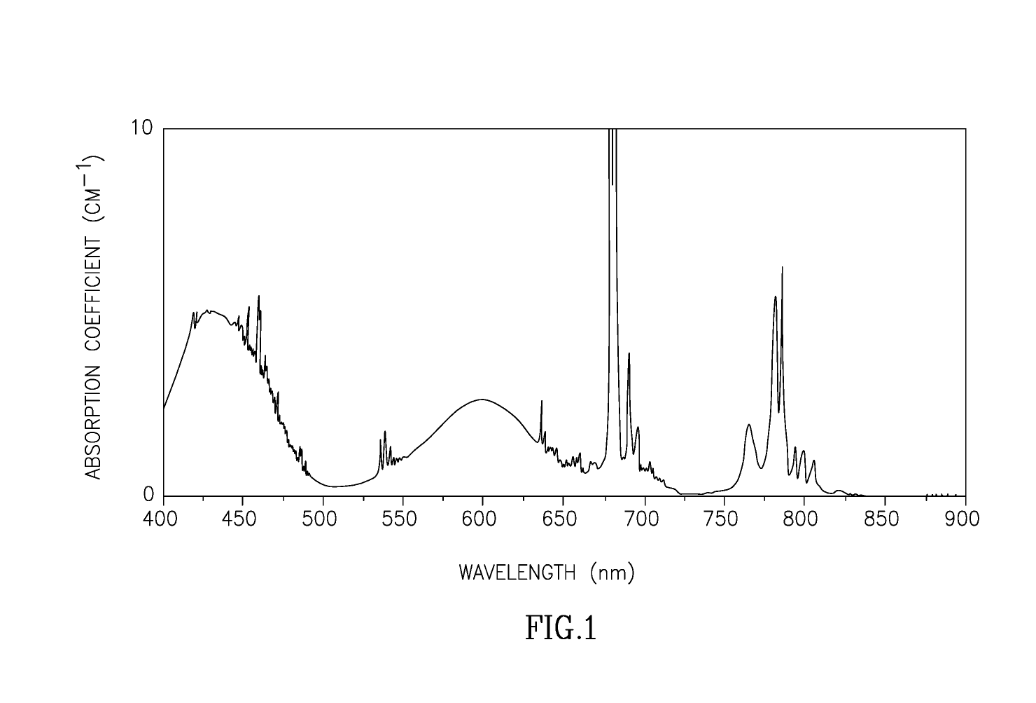

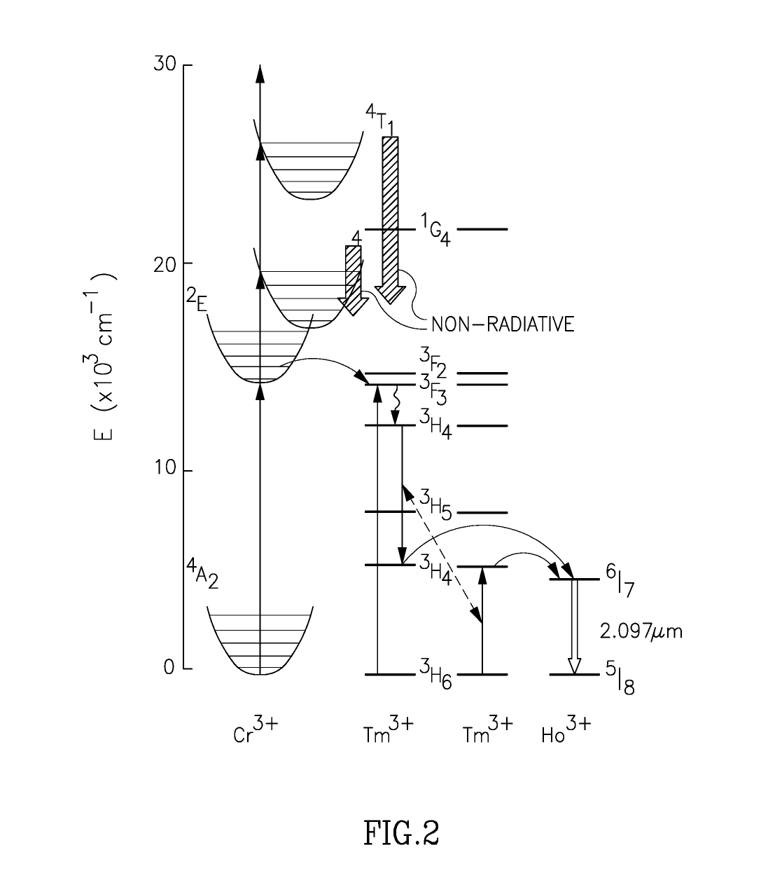

As can be seen in FIG. 1, a typical flash lamp emission spectrum is characterized by peaks at the blue and green regions. Blue regions are responsible for the excited energy level ⁴T₁ and ⁴T₂ of the Cr ions which are then relaxed in a non-radiate relaxation, as shown in FIG. 2. This non-radiate relaxation increases the thermal load of the rod. Therefore, one solution offered by the present invention is to dope a flash lamp that has a glass surface with one or more of Europium or Samarium to suppress the blue emission of the lamp and to reduce the thermal load of the laser crystal. Such a solution may increase the overall efficiency and output of the Ho laser.

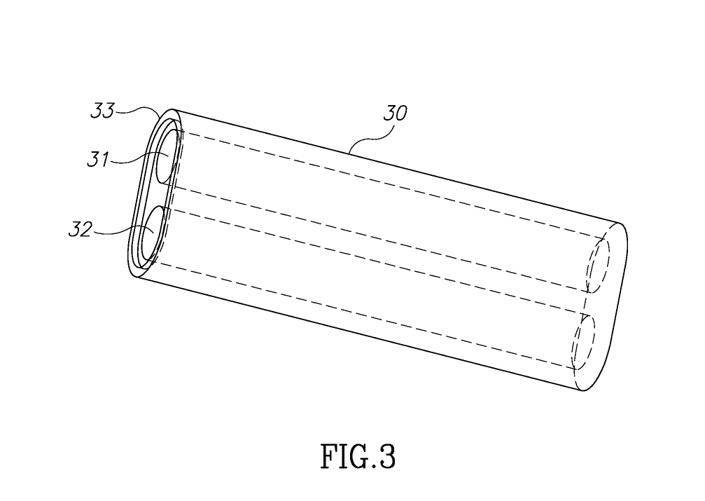

According to another embodiment of the present invention, the doped Samarium and/or Europium may be incorporated into a glass structure which holds and couples a laser rod and a pumping flash light. As can be seen in FIG. 3, a glass structure 30 is designed to have at least two parallel hollow tube cavities 31 and 32 which are configured to contain the lasing rod and the flashlamp respectively. Parallel cavities 31 and 32 are spaced apart by distance D which is defined by the width of the separating wall 33. Glass element 30 is made of a material which is transparent to the pumping light and is configured among other things to transfer the light emitted from the pumping lamp to the laser rod. Thus, if a pumping laser rod is placed in, for example, tube cavity 31 and the flashlamp in tube cavity 32, when the flashlamp is activated, the light emitted from the flashlamp will excite the laser rod in tube cavity 31. The glass element 30 may be doped with Samarium and/or Europium material to absorb part of the blue emission irradiated from the lamp in order to reduce the thermal load of the laser crystal. By reducing the thermal load on the lasing rod, the overall efficiency and output of the laser is increased.

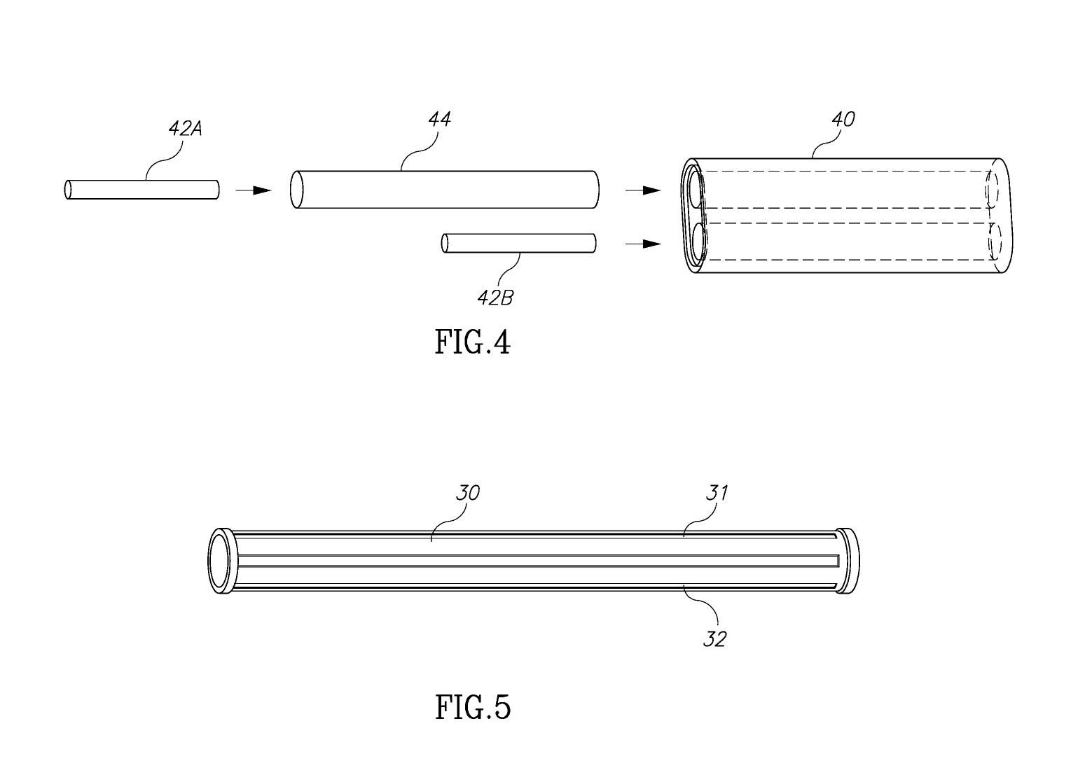

In another embodiment of the invention, a glass structure 40, shown in FIG. 4, is employed which can be used to couple a laser rod and a pumping flash light but not being doped with Samarium or Europium. In this embodiment, the laser rod 42A is placed in a glass tube 44 which includes a doping material of Samarium and/or Europium. This assembly of laser rod 42A in the glass tube 44 is then placed in one of the cavities of the glass structure shown 40 in FIG. 4, as shown by the arrows in FIG. 4. It is to be understood that the doped glass tube 44 may encompass either laser rod 42A or lamp 42B, as shown in FIG. 4

According to another aspect of the invention, a lamp-pumped laser cavity is disclosed. Such a laser cavity includes at least an element 30 doped with Europium and/or Samarium material, and referring again to FIG. 3, a Holmium doped laser rod is placed in one of cavities 31 or 32 and a pumping lamp is placed in the other cavity.

According to one embodiment of the present invention such a Holmium doped rod is a CTH:YAG laser rod. FIG. 5 shows a side view of glass element 30. Parallel cavities 31 and 32 are also shown in FIG. 5.

According to another aspect of the present invention, a Holmium laser system is provided that has a single laser cavity which is configured to produce at least 20W or at least 30W or at least 40W or at least 50W or at least 55W or at least 60W in its output. However, according to another aspect of the present invention, a multi-cavity laser system is provided having at least one laser cavity with an improved efficiency described above. Such a multi cavity laser system is configured to guide the optical output of each single laser cavity into a common path. For example, a rotating mirror may be used to combine the separate beams of the multi cavity laser system into such a common optical path. Such a system is sold by Lumenis Ltd. of Yokneam, Israel under the product name Versapulse® and is disclosed in U.S. pending application Ser. No. 14/660,979, filed Mar. 8, 2015 and entitled Multiple Laser Cavity Apparatus, the entire contents of which is herein incorporated by reference.

In yet another aspect of the invention, a cooling system is configured to cool a coolant fluid and to circulate such a coolant fluid in the laser cavity in the vicinity of the laser rod or the flash lamp in order to reduce and control its temperature. Lowering the temperature of the laser rod increases its lasing efficiency by reducing its thermal load. According to this aspect of the invention, the cooling system reduces the temperature of the laser to below 15 degrees centigrade. Alternatively, the cooling system may reduce the temperature to below 10 degrees or below 6 degrees centigrade. According to another embodiment of this aspect of the invention, the cooling system may be configured to operate the laser at about 5 degrees centigrade. Such a cooling system is disclosed in co-pending application Ser. No. 14/660,979, the entire contents of which are incorporated herein by reference.

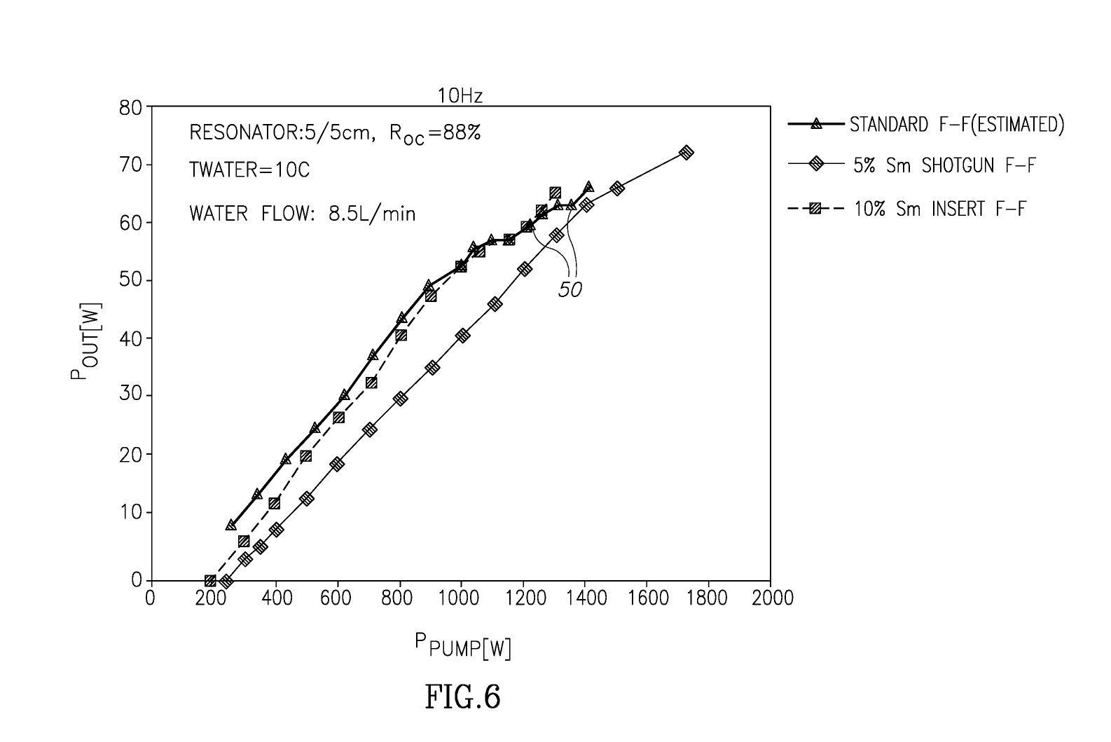

FIGS. 6 to 11 illustrate comparative data based on the invention described above. Measurements of output lasing energies as a function of input optical energy (pumped) at frequencies 10 Hz, 15 Hz, 20 Hz, 25 Hz, 30 Hz and 40 Hz are illustrated.

At low frequencies and low energies, the optical efficiency of a standard cavity having no doping Samarium is higher than the Samarium doped cavities. However, at high frequencies or energy levels the optical efficiency of the Samarium doped cavities are superior, as will be seen in FIGS. 6 to 11.

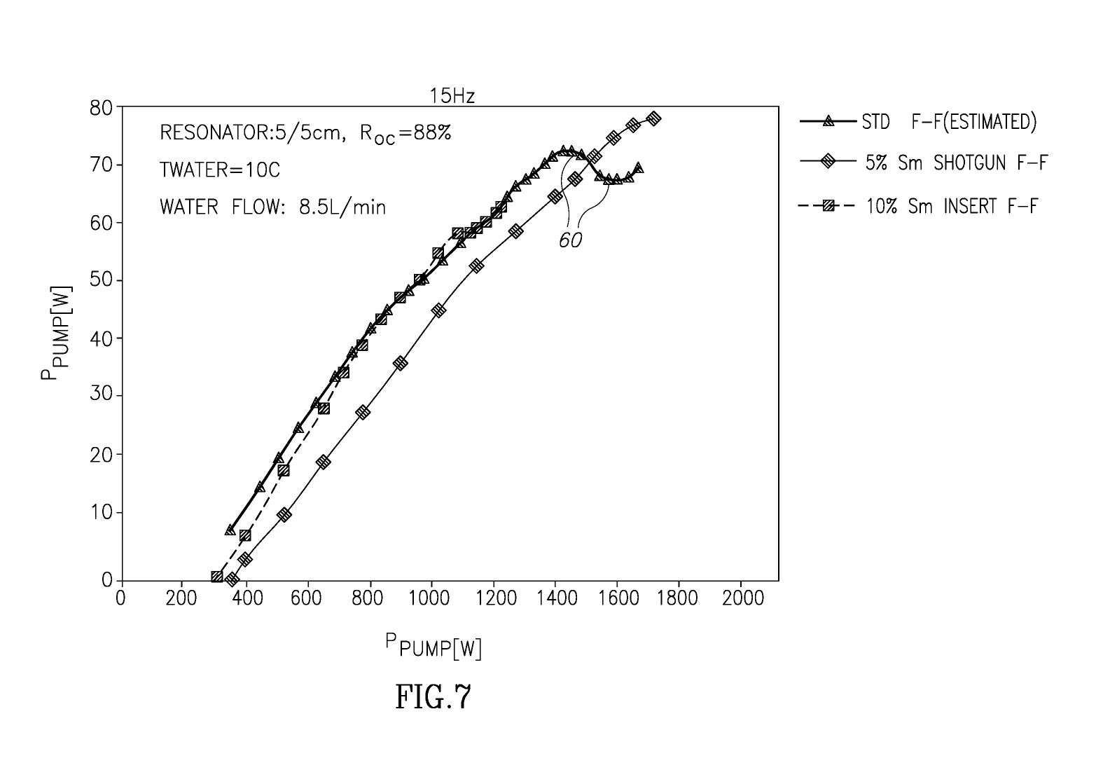

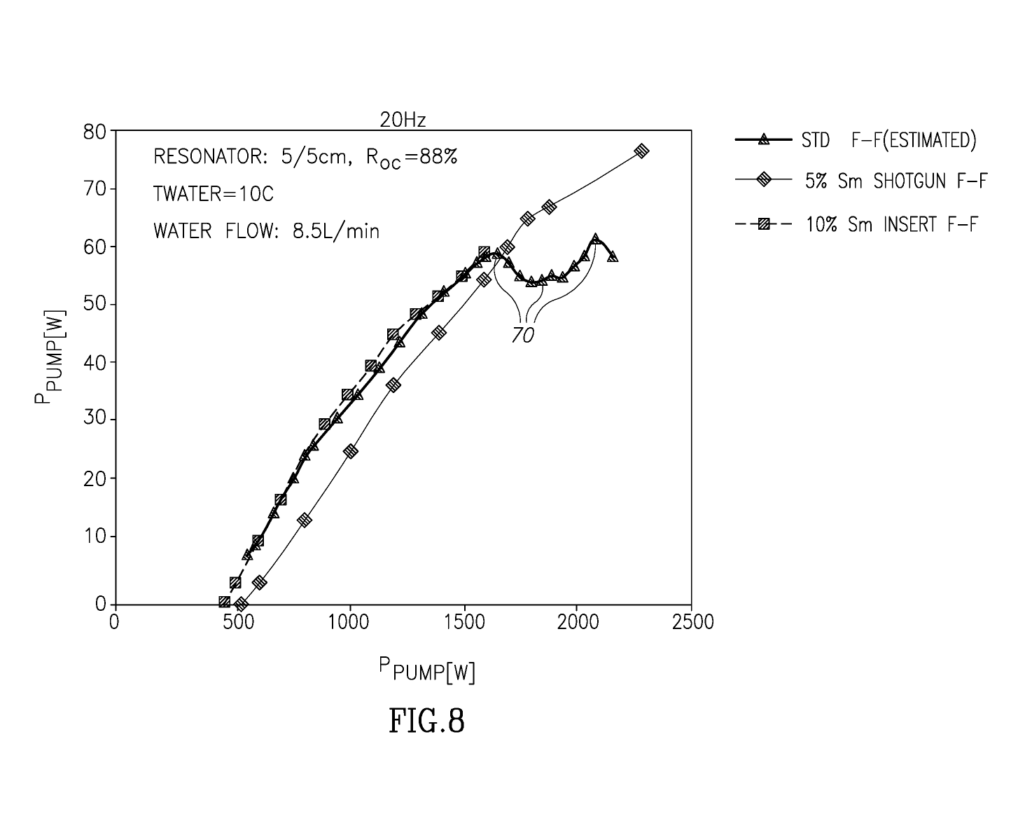

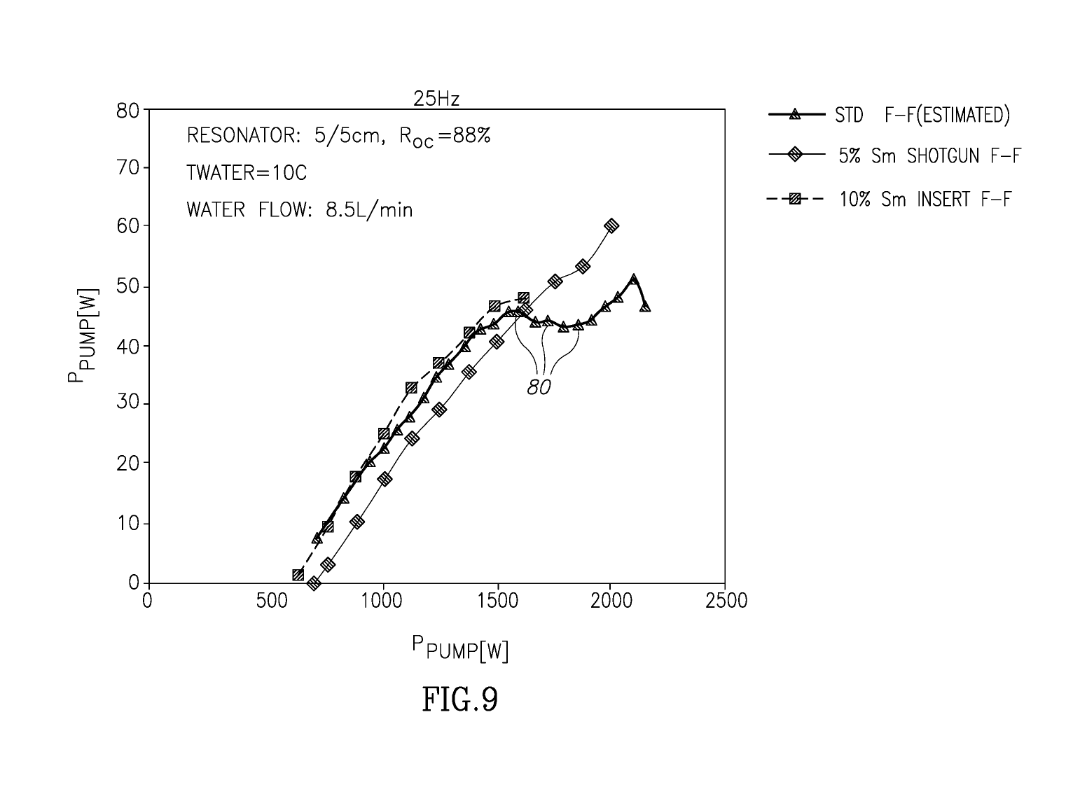

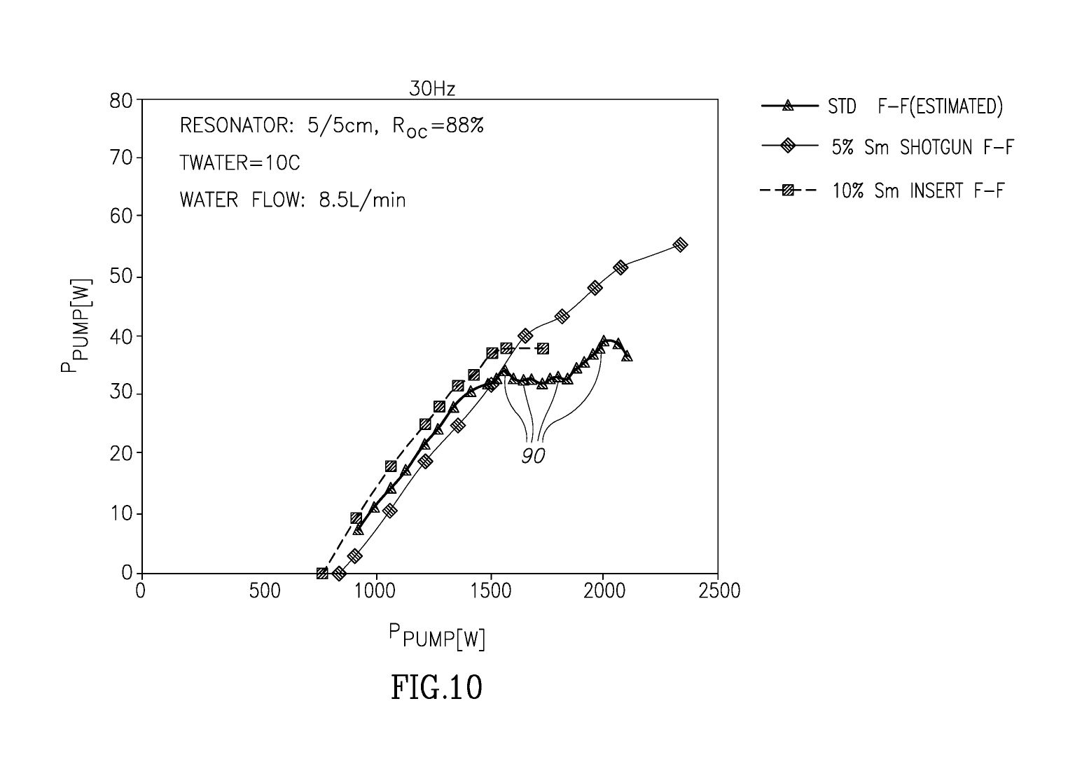

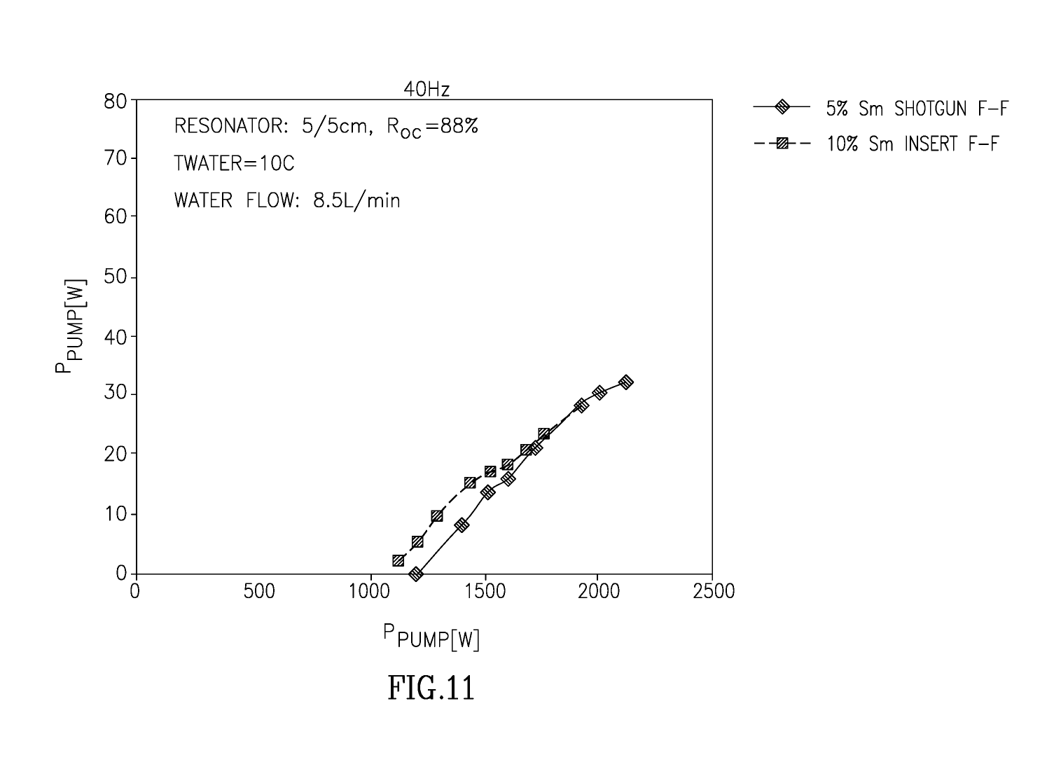

However, even at low frequencies the non-doped cavity, at a certain level of pumped energy, shows losses in its linear behavior, as can be seen in 50 in FIGS. 6 and 60 in FIG. 7. Linearity deteriorates even greater at higher frequencies as can be seen in 70 in FIG. 8, 80 in FIGS. 9, and 90 in FIG. 10. FIG. 11 illustrates linearity at 40 Hz.

In contrast, as shown in the above-mentioned figures, whenever the non-doped cavity loses linearity, the Samarium doped cavity maintains its linearity behavior. This is also true even at high input powers or high frequencies. Moreover, the optical efficiency of the doped cavity in these regimes supersedes those of the non-doped cavity. It should be mentioned that the linear behavior is the desired if not required behavior of the cavity. It also shows that it can operate optically effectively at the high zones of frequencies and energies. A non-linear behavior is an indication of optical inefficiency and higher heat load on the laser rod.

For example, FIG. 10 shows that about 55W output energy may be achieved at 30 Hz. These performances are much better than any currently available cavity on the market. It is another aspect of the present invention to operate a doped Holmium laser cavity in any of the ranges and combinations of energies and frequencies as shown in any of FIGS. 6-11.

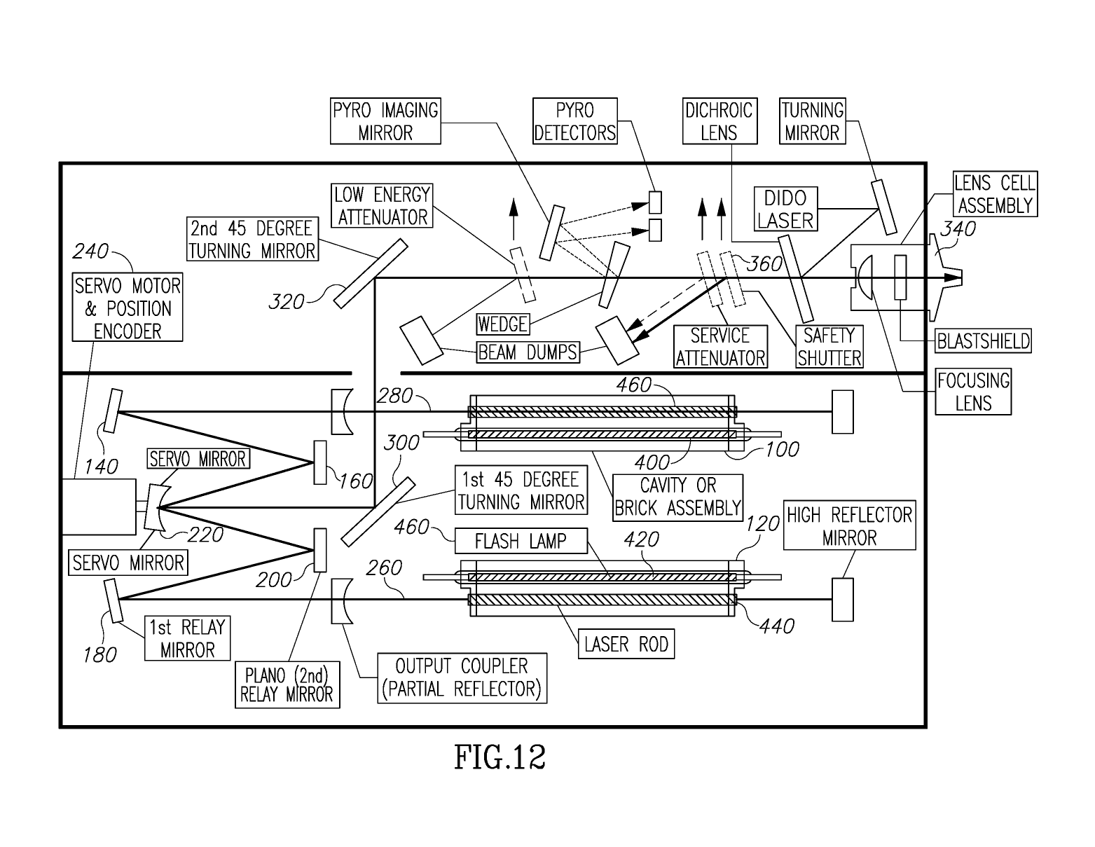

Turning now to FIG. 12, this figure shows a schematic of a multiple laser cavity apparatus. Although only two laser cavities are shown, this is due to the perspective of the drawing. It can be seen that in a perspective orthogonal to the page that two additional laser cavities can be accommodated. As can be seen in FIG. 12, the laser cavities 100 and 120 output two laser beams to an arrangement whereby each impinges on mirrors 140, 160, 180 and 200. Those mirrors then reflect the respective laser beam onto a rotating mirror 220 which is driven by a servo motor and position encoder 240. The rotating mirror, as can be seen in FIG. 12, then directs the two light beams 260 and 280 from, respectively, laser cavities 120 and 100 onto first and second mirrors 300 and 320 and eventually to output 340. The third and fourth cavities have similar optical paths like 100 and 120 and they also combine in the rotating mirror 300. Mirrors 300 and 320 are common for the four laser beams from the four laser cavities. The beams are separated in time but only slightly. They are sequentially generated by the four laser cavities. The rotating mirror needs to arrive at the right position at the right time to reflect the appropriate beam along the same optical path. If not so, the optical paths will differ from one another. A safety shutter 360 is also included the light path as seen in FIG. 12

In another aspect, apparatus such as described above which includes multiple laser cavities or even a singular laser cavity requires a source of power to charge the flash lamps such as 400 and 420. Conventionally, in known devices this may be accomplished by charging one or more large capacitors in a capacitor bank and rapidly discharging those capacitors into the flash lamps thus causing excitation of the laser rods 440 and 460 as seen in FIG. 12.

The doping scheme of the present invention may be incorporated in one, two, three but preferably all four laser cavities. This may be accomplished, in the system shown in FIG. 12, by doping the flashlamps 400, 420 (and the other two laser cavities not shown) with one or more of Samarium or Europium. Alternatively, any of the doping schemes described herein (for example the doping scheme of FIG. 4) may be implemented in the laser cavities shown in FIG. 12 to achieve the beneficial goals described herein.

What we claim is:

1. A method of improving the operation of a laser assembly, comprising:
providing a glass element, wherein the glass element comprises two, parallel glass tubes for holding each one of a laser rod or a pumping flash lamp;
doping at least one of the two parallel glass tubes of the glass element with one or more of Samarium or Europium, whereby, upon excitation, the doped glass element absorbs at least part of the blue emission spectrum irradiated from the pumping flash lamp when activated.

2. The method of claim 1, wherein the laser rod is a Holmium doped laser rod.

3. The method of claim 1, wherein the laser rod is a CTH:YAG doped laser rod.

4. A pumped laser cavity comprising two tubes forming two parallel glass cavities, a flashlamp for placement in one of the glass cavities, wherein the flashlamp is doped with one or more of Samarium or Europium.

5. A pumped laser cavity assembly, comprising:
two parallel tubes forming two glass cavities;
a flashlamp within one of the glass cavities;
a laser rod within the other of the two glass cavities;
a glass tube surrounding one or both of the flashlamp or the laser rod;
wherein the glass tube is doped with one or more of Samarium or Europium.

6. A method of improving the operation of a laser assembly, comprising:
providing two parallel glass tubes, each having a cavity for holding one of a laser rod or a pumping flash lamp;
doping the one or more glass tubes with one or more of: Samarium or Europium, whereby, upon excitation, the one or more doped glass tubes absorb at least part of the blue emission spectrum irradiated from the pumping flash lamp.

7. The method of claim 6, wherein the laser rod is a Holmium doped laser rod.

8. The method of claim 6, wherein the laser rod is a CTH:YAG doped laser rod.

9. A pumped laser cavity assembly, comprising:
two parallel glass tubes forming two cavities;
a flashlamp within one of the cavities;
a Holmium doped laser rod within the other of the cavities;
wherein one or more of the glass tubes is doped with one or more of Samarium or Europium.

10. A method of manufacturing a laser assembly, comprising:
providing a glass element, wherein the glass element comprises two, parallel glass tubes for holding each one of a laser rod or a pumping flash lamp; and,
doping at least one of the two parallel glass tubes of the glass element with one or more of Samarium or Europium.

11. The method of claim 10, whereby, upon excitation of the doped laser assembly, the doped glass element absorbs at least part of the blue emission spectrum irradiated from the pumping flash lamp.

12. A multiple cavity laser system comprising:
a controller configured to operate the system;
a plurality of glass tubes forming laser cavities, each of the laser cavities including a flashlamp and a laser rod, the plurality of laser cavities also having an output end wherein, when activated by the controller, an output laser beam is emitted from the output end of each of the laser cavities;
the controller redirecting the output laser beams along a common optical axis, wherein the output laser beams of the plurality of laser cavities are combined along the common optical axis; and,
wherein one or more of the plurality of glass tubes forming the laser cavities are doped with one or more of Samarium or Europium.
